(19) United States
(12) Patent Application Publication
(10) Pub. No.: US 2017/0191736 A1
(43) Pub. Date: Jul. 6, 2017

(54) REFRIGERATOR WITH INTEGRATED HINGE ASSEMBLY AND DOOR CLOSURE MECHANISM

(71) Applicant: WHIRLPOOL CORPORATION, BENTON HARBOR, MI (US)

(72) Inventors: Alexandre Fleig, St. Joseph, MI (US); Rohan Gore, Stevensville, MI (US); Robert J. Haeberle, St. Joseph, MI (US); Dakota E. Kosek, Benton Harbor, MI (US); Tao Liu, St. Joseph, MI (US); Axel Julio Ramm, St. Joseph, MI (US); Joshua J. Wittes, Berrien Springs, MI (US)

(73) Assignee: WHIRLPOOL CORPORATION, BENTON HARBOR, MI (US)

(21) Appl. No.: 14/985,586

(22) Filed: Dec. 31, 2015

(51) Int. Cl. F25D 23/02; F25D 25/02; E05D 3/04; F25D 23/04

(52) U.S. Cl. CPC F25D 23/028; F25D 23/04; F25D 25/025; E05D 3/04; F25D 2323/024

(57) ABSTRACT

A refrigerator includes a door that is vertically adjustable via a height adjustable door hinge assembly. The door hinge assembly includes a bracket member having a mounting aperture with a hinge shaft extending upwardly from the bracket member as received in the mounting aperture. A hinge bushing is comprised of an inner portion that is received in an outer portion and fixedly coupled thereto to define a receiving channel disposed therebetween. The hinge shaft is received in the receiving channel of the hinge bushing in assembly. A set screw is threadingly coupled to a threaded aperture disposed in an inner cavity of the hinge shaft. In assembly, the set screw abuts a lower surface of the inner portion of the hinge bushing to vertically adjust a position of the hinge bushing as a vertical position of the set screw is adjusted.

### BACKGROUND

The present concept relates to a hinge assembly for a refrigerator cabinet, and more particularly, to a height adjustable hinge assembly for providing a height adjustable door for a refrigerator cabinet.

### SUMMARY

One aspect of the present concept includes a refrigerator having a refrigerator cabinet with a front opening. A door is rotatably coupled to the refrigerator cabinet and is operable between open and closed positions relative to the front opening. A door closure assembly is received in a channel disposed in an interior of the door, and the door closure assembly includes a receiving aperture. A bracket member is fixed to a front surface of the refrigerator cabinet and is disposed adjacent to the front opening of the refrigerator cabinet. A hinge shaft upwardly extends from the bracket member and is configured to be at least partially received in the receiving aperture of the door closure assembly. A hinge bushing is installed between the hinge shaft and the door closure assembly. A set screw is threadingly coupled to and vertically adjustable along a threaded aperture disposed in an inner cavity of the hinge shaft. The set screw abuts the hinge bushing to vertically adjust a position of the hinge bushing in response to vertical adjustment of the set screw along the threaded aperture.

Another aspect of the present concept includes a refrigerator having a refrigerator cabinet with a front opening. A door is rotatably coupled to the refrigerator cabinet and is operable between open and closed positions relative to the front opening. A door closure assembly is received in a channel disposed in a bottom surface of the door, wherein the door closure assembly includes a receiving aperture with a downwardly extending pivot shaft. A bracket member is coupled to a front surface of the refrigerator cabinet and extends outwardly therefrom. A hinge shaft upwardly extends from the bracket member and includes a cylindrical body portion having an inner cavity. A hinge bushing includes an outer portion and an inner portion with a receiving channel disposed between the inner portion and outer portion. The cylindrical body portion of the hinge shaft is received in the receiving channel of the hinge bushing in assembly. A set screw is threadibly coupled to and vertically adjustable along a threaded aperture disposed in the inner cavity of the hinge shaft. The set screw abuts a lower surface of the inner portion of the hinge bushing to vertically adjust a position of the hinge bushing in response to a rotation of the set screw.

Yet another aspect of the present concept includes a height adjustable door hinge assembly which includes a bracket member having a mounting aperture disposed at a distal end thereof. A hinge shaft is received in the mounting aperture of the bracket member and includes a cylindrical body portion that upwardly extends from the bracket member. A hinge bushing includes an inner portion that is received in an outer portion to define a receiving channel therebetween. The cylindrical body portion of the hinge shaft is received in the receiving channel defined between the inner portion and outer portion of the hinge bushing. A set screw is threadingly coupled to a threaded aperture disposed in the hinge shaft, such that the set screw abuts the inner portion of the hinge bushing to vertically adjust a position of the hinge bushing in response to vertical adjustment of the set screw.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a perspective view of a refrigerator having multiple doors and drawers disposed on a front surface thereof;

FIG. 2A is a bottom perspective view of a right hand door from the refrigerator of FIG. 1;

FIG. 2B is a fragmentary perspective view of a mounting portion of the door of FIG. 2A taken at location IIB;

FIG. 3A is a perspective view of a door closure assembly;

FIG. 3B is a cross-sectional view of the mounting portion taken along line IIIB of FIG. 2B;

FIG. 4A is a bottom perspective view of the door of FIG. 2A mounted to the refrigerator of FIG. 1;

FIG. 4B is a fragmentary perspective view of the mounting portion of the door of FIG. 4A taken at location IVB;

FIG. 4C is a cross-sectional view of the mounting portion of FIG. 4B taken at line IVC;

FIG. 5A is a perspective view of a hinge assembly including a bracket member, a hinge shaft and a hinge bushing;

FIG. 5B is a top plan view of the hinge assembly of FIG. 5A;

FIG. 5C is a top plan view of the hinge assembly of FIG. 5B with a door closure assembly mounted thereon;

FIG. 6 is a cross-sectional view of the hinge assembly of FIG. 5A taken at line VI;

FIG. 7A is a cross-sectional view of the hinge assembly of FIG. 5A as coupled to a door closure assembly;

FIG. 7B is a perspective view of a pivot shaft for a door closure assembly;

FIG. 8A is a top perspective view of an inner portion of a hinge bushing;

FIG. 8B is a bottom perspective view of the inner portion of the hinge bushing of FIG. 8A;

FIG. 9A is a top perspective view of an outer portion of a hinge bushing;

FIG. 9B is a bottom perspective view of the outer portion of the hinge bushing of FIG. 9A:

FIG. 10A is a top perspective view of the inner portion of the hinge bushing of FIG. 8A received in the outer portion of the hinge bushing of FIG. 9A;

FIG. 10B is a bottom perspective view of the hinge bushing of FIG. 10A;

FIG. 10C is a cross-sectional view of the hinge bushing of FIG. 10B taken at line XC.

FIG. 11A is an exploded view of a hinge bushing according to another embodiment;

FIG. 11B is a top plan view of the hinge bushing of FIG. 11A in an assembled condition;

FIG. 11C is a bottom plan view of the hinge bushing of FIG. 11B; and

FIG. 11D is a cross-sectional view of the hinge bushing of FIG. 11B.

### DETAILED DESCRIPTION OF EMBODIMENTS

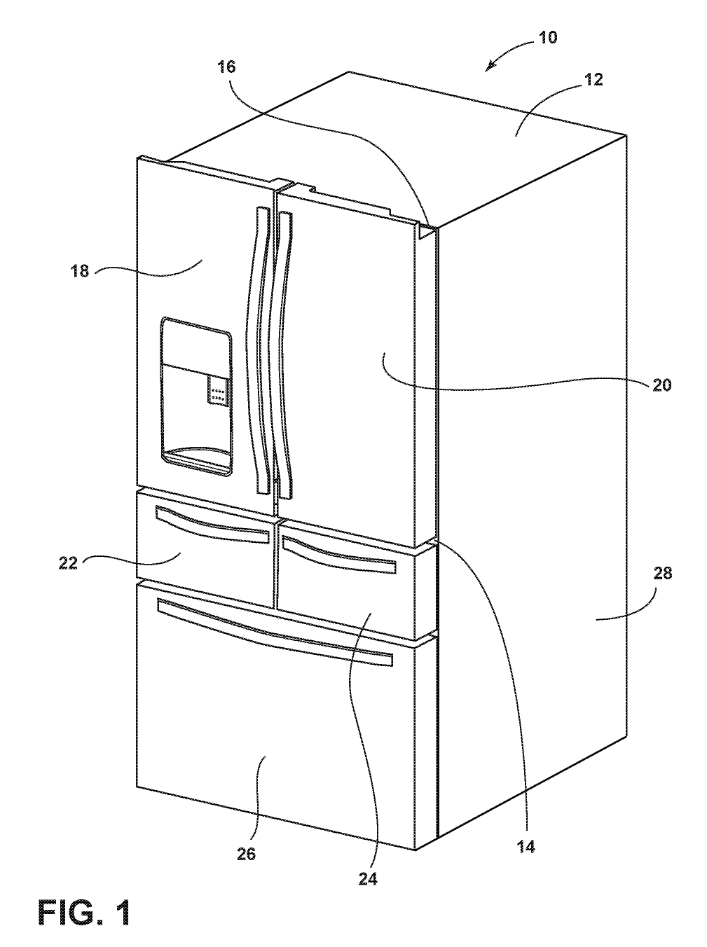

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

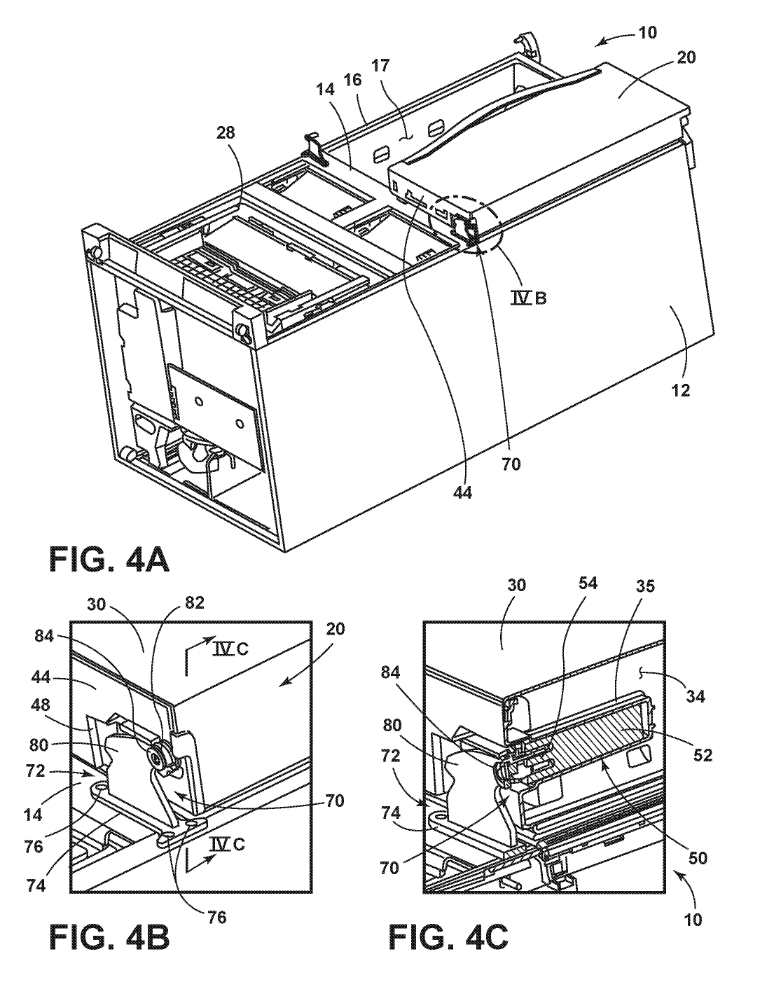

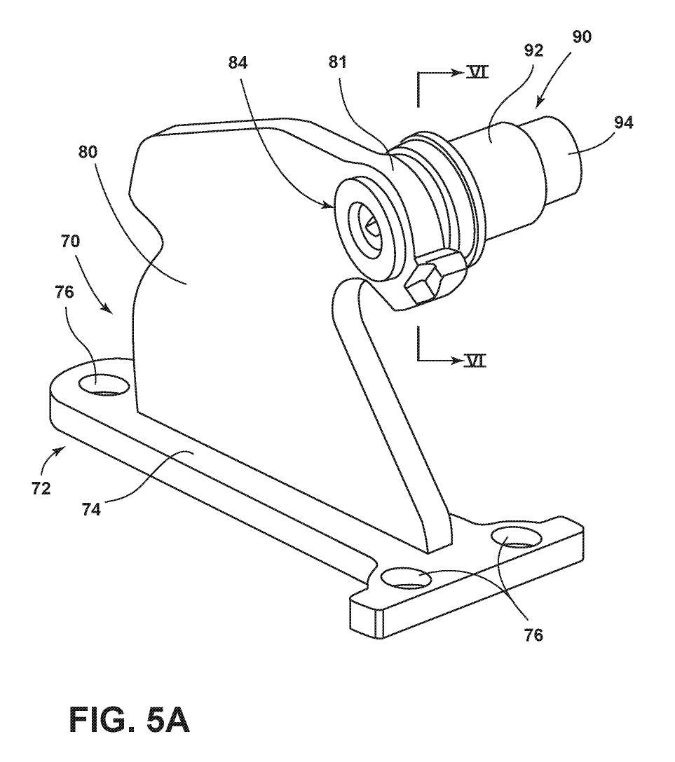

Referring now to FIG. 1, a refrigerator 10 is shown having a refrigerator cabinet 12. The refrigerator cabinet 12 includes a front surface 14 that is generally disposed around a front opening 16 of the refrigerator cabinet 12. The refrigerator cabinet 12 is contemplated to be an insulated space for storing fresh food items having first and second doors 18, 20 that are rotatably coupled to the front surface 14 of the refrigerator cabinet 12 for selectively providing access to a storage space 17 (FIG. 4A) of the refrigerator cabinet 12. In the embodiment shown in FIG. 1, the refrigerator 10 further includes first and second drawers 22, 24 which also provide access to the refrigerator cabinet 12. A bottom drawer 26 is shown in FIG. 1 and contemplated to provide access to a freezer cabinet 28 disposed below the refrigerator cabinet 12. The refrigerator 10 shown in FIG. 1 is an exemplary embodiment of a refrigerator for use with the present concept, and is not meant to limit the scope of the present concept in any manner. As noted above, the first and second doors 18, 20 are rotatably coupled to the refrigerator cabinet 12, and this coupling is provided by height adjustable hinge assemblies of the present concept which are designed to provide vertical adjustment for the first and second doors 18, 20 as mounted to the refrigerator cabinet 12.

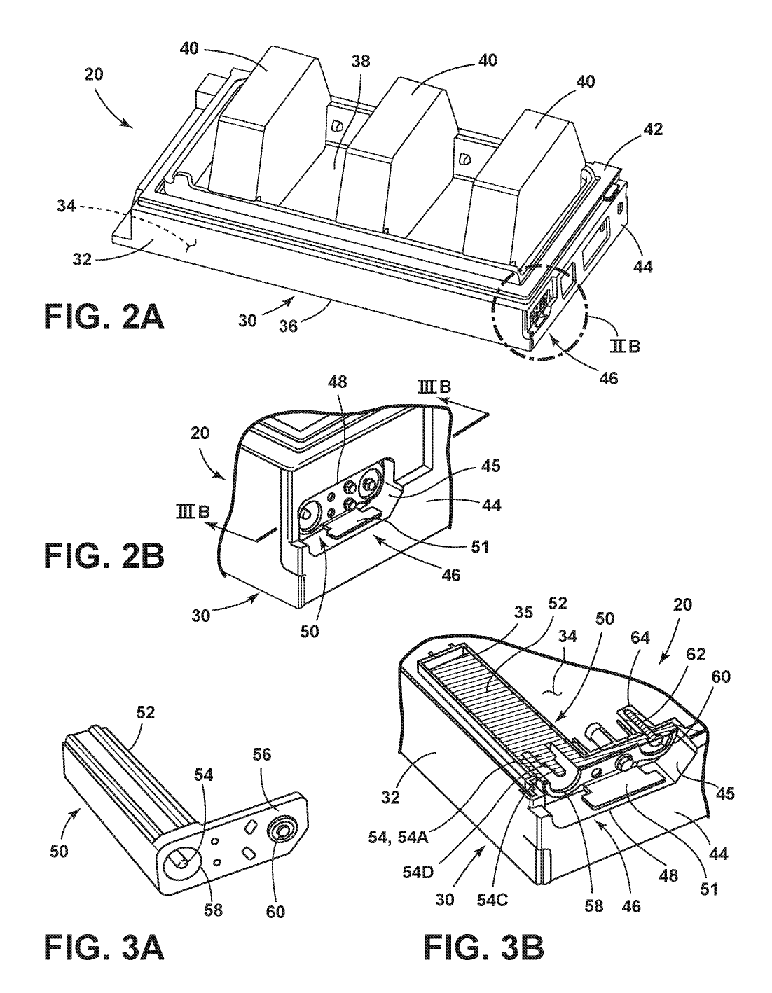

Referring now to FIG. 2A, a door is shown similar to second door 20 mounted to the refrigerator cabinet 12 in FIG. 1. The door shown in FIG. 2A is an exemplary door which is described herein as door 20, however, it is one of ordinary skill in the art will understand that the features of door 20 are also applicable to door 18 in a reverse manner. In FIG. 2A, door 20 includes a body portion 30 surrounded by an outer shell 32, wherein the body portion 30 generally includes an interior space 34 which is contemplated to be an insulated interior space 34. The door 20 further includes an outer surface 36 and an inner surface 38, wherein the inner surface 38 includes a plurality of shelves 40. A seal 42 is disposed on the inner surface 38 and is configured to seal against the front surface 14 of the refrigerator cabinet 12 when the door 20 is in a closed position as shown in FIG. 1. The door 20 is configured to be rotatably mounted to the refrigerator cabinet 12 (FIG. 1) between open and closed positions, and includes a mounting portion identified at location IIB on a bottom surface 44 of the body portion 30. The mounting portion is generally identified by reference numeral 46 and is further described below with reference to FIG. 2B.

Referring now to FIG. 2B, the mounting portion 46 is shown which includes an aperture 48 disposed in the bottom surface 44 of the body portion 30 of the door 20. The aperture 48 provides access to a door closure assembly 50 that is further described below. The aperture 48 exposes an interior wall 45 in the bottom surface 44 which has a hinge stopping bracket 51 disposed adjacent thereto. The hinge stopping bracket 51 is configured to abut a portion of a hinge assembly when the door 20 is in a full open position. With the configuration of the present concept, the hinge stopping bracket 51 is substantially concealed in the aperture 48 disposed in the bottom surface 44 of the body portion 30 of the door 20. This concealed arrangement of the hinge stopping bracket 51 provides a novel configuration with a pleasing aesthetic to the overall mounting portion 46, wherein the hinge stopping bracket 51 is not externally visible to a user.

Referring now to FIG. 3A, the door closure assembly 50 is shown in a perspective view having a body portion 52 with a pivot shaft 54 extending downwardly therefrom. The door closure assembly 50 further includes a bottom plate 56 having a receiving aperture 58 which is disposed around the pivot shaft 54, thereby providing access to the pivot shaft 54. A mounting aperture 60 is also disposed on the bottom plate 56 and is configured to mount the door closure assembly 50 to the door 20 at mounting portion 46.

Referring now to FIG. 3B, the door closure assembly 50 is shown disposed within an interior 34 of the door 20, wherein the body portion 52 of the door closure assembly is received in a channel 35 disposed within the interior 34 of the door 20. A fastener 62 is shown coupled to the mounting aperture 60 of the door closure assembly 50 and is received in a mounting boss 64 disposed within the interior 34 of the door 20. In this way, the door closure assembly 50 is securely mounted to the door 20 at an interior portion 34 thereof and can be mounted to a hinge assembly as further described below. Specifically, the pivot shaft 54 of the door closure assembly 50 is mounted to a hinge assembly as further described below. In the view of FIG. 3B, the pivot shaft 54 is shown to have a generally stepped configuration with an upper portion 54A disposed above a lower portion 54C with a transition portion 54D disposed therebetween. The upper portion 54A is larger than the lower portion 54C, and the transition portion 54D is generally angled from the larger upper portion 54A to the smaller lower portion 54C. As shown in FIG. 3B, the pivot shaft 54 is generally disposed centrally within the receiving aperture 58 of the door closure assembly which is accessible through aperture 48 of the bottom surface 44 of the door 20. The aperture 48 disposed in the bottom surface 44 of the door 20 further provides access to the fastener 62 and mounting aperture 60 for securely mounting the door closure assembly 50 the channel 35 of the door 20.

Referring now to FIG. 4A, the door 20 is shown mounted on the refrigerator cabinet 12 via a hinge assembly 70. The hinge assembly 70 is a lower hinge assembly which rotatably couples the door 20 to the front surface 14 of the refrigerator cabinet 12. The hinge assembly 70 is disposed at the bottom surface 44 of the door 20 and, as noted above, is configured to vertically adjust a position of the door 20 as coupled to the refrigerator cabinet 12. In the embodiment shown in FIG. 4A, a storage compartment 17 of the refrigerator 10 is shown, and the door 20 is in the closed position relative to the storage compartment 17 of the refrigerator cabinet 12.

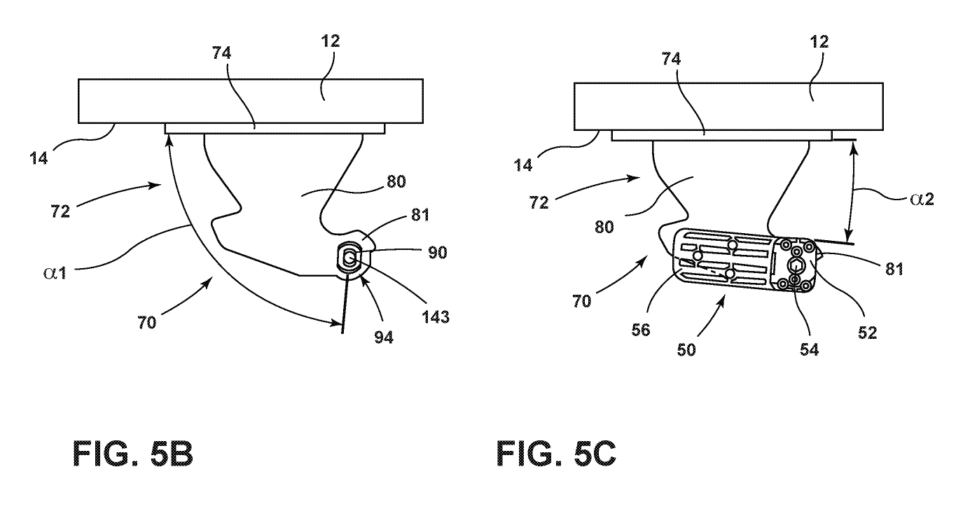

Referring now to FIG. 4B, a bracket member 72 is shown coupled to the front surface 14 of the refrigerator 10 at a mounting plate 74 via mounting apertures 76 which are configured to receive fasteners for fixedly connecting the bracket member 72 to the front surface 14 of the refrigerator 10. The bracket member 72 further includes an outwardly extending bracket portion 80 having a mounting aperture 82 disposed at a distal end 81 (FIG. 5A) thereof. The mounting aperture 82 is configured to receive a hinge shaft 84 therethrough which upwardly extends from the bracket portion 80 of the bracket member 72.

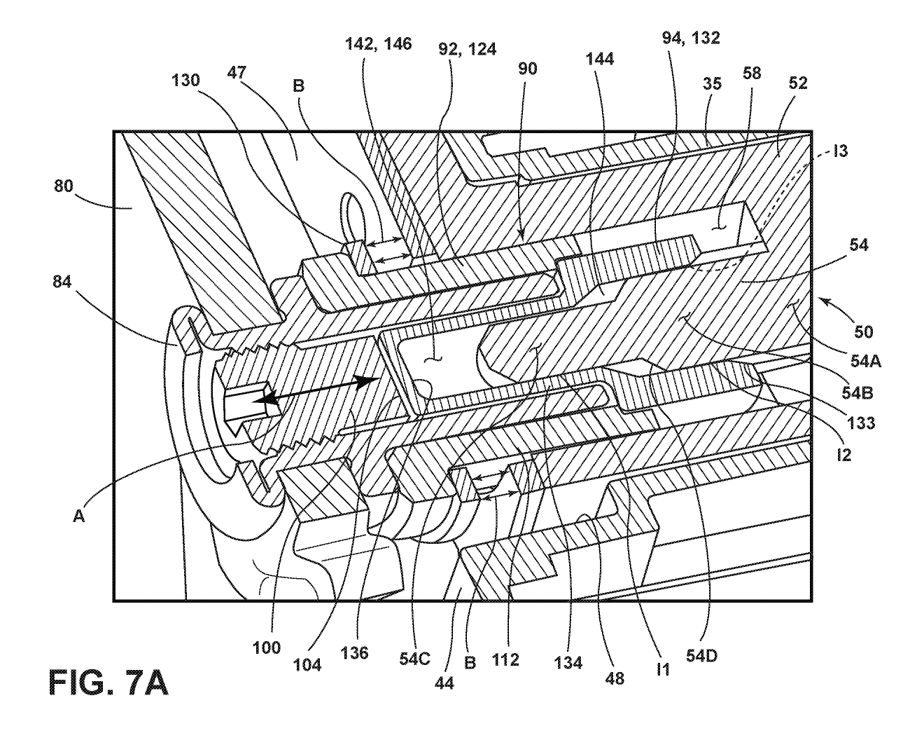

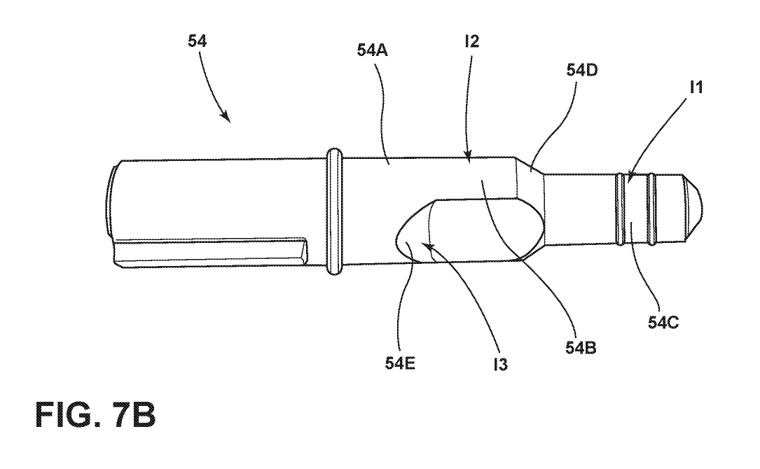

Referring now to FIG. 4C, the hinge assembly 70 is shown with the door closure assembly 50 disposed within the channel 35 of the door 20 and the hinge shaft 84 operably coupled to the pivot shaft 54 of the door closure assembly 50, as further described below with reference to FIG. 7A.

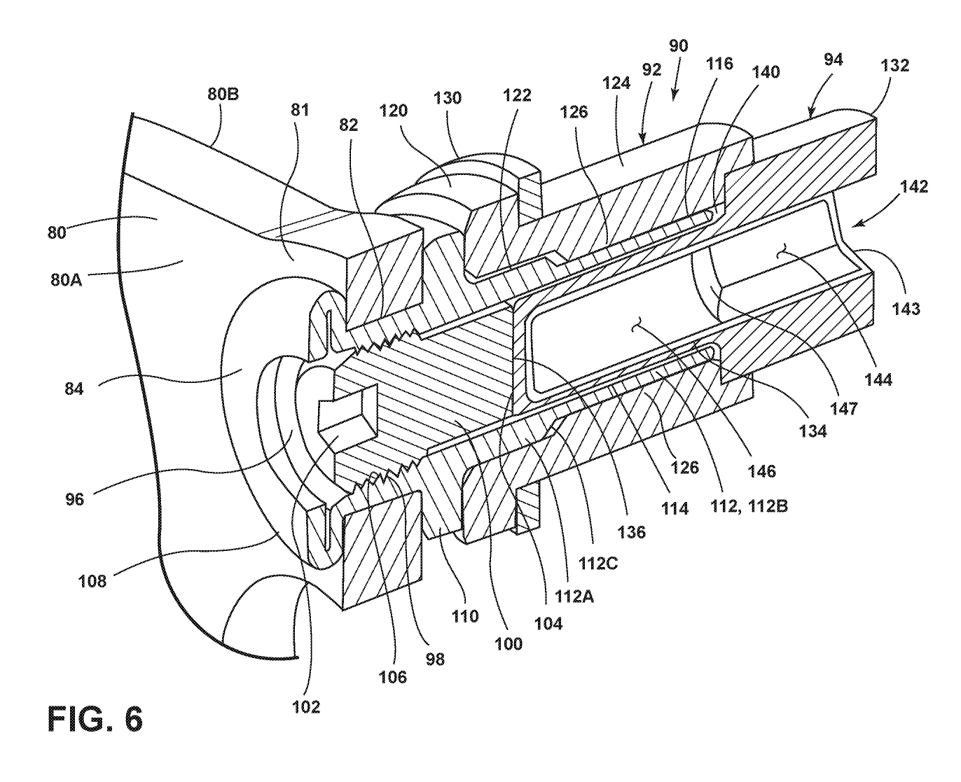

Referring now to FIG. 5A, the hinge assembly 70 is shown with the hinge shaft 84 disposed in mounting aperture 82 (better shown in FIG. 6) disposed at the distal end 81 of the bracket portion 80 of the bracket member 72. A hinge bushing 90 includes an outer portion 92 having an inner portion 94 received within the outer portion 92, and the hinge bushing 90 is mounted to the hinge shaft 84 as best shown in FIG. 6. This arrangement is further shown in FIG. 5B and is further shown with the door closure assembly 50 mounted thereto in FIG. 5C, as further described below.

Referring now to FIG. 6, a cross-sectional view of the bracket portion 80, hinge shaft 84 and hinge bushing 90 is shown. In FIG. 6, the hinge shaft 84 includes a threaded aperture 96 which has internal threads 98 disposed thereon. The threaded aperture 96 is configured to receive a set screw 100 having a head portion 102 and an abutment surface 104. The set screw 100 further includes external threads 106 which are configured to threadingly couple the set screw 100 with the internal threads 98 of the threaded aperture 96 of the hinge shaft 84. The set screw 100 is received in the threaded aperture 96 of the hinge shaft 84 for vertical adjustment therein along the path as indicated by arrow A shown in FIG. 7A. Vertical adjustment of the set screw 100 results in a vertical adjustment of the hinge bushing 90 which further results in adjustment of the vertical position of an associated door, such as door 20. The adjustment of the set screw 100 is generally conducted by a user using a tool, such as a screwdriver or Allen's wrench that is configured to engage with the head portion 102 of the set screw 100. The adjustment of the door takes place through the hinge shaft 84, which is accessible from an underside of the door 20 near bottom surface 44 as shown in FIG. 4B. In this way, the vertical position of the door 20 can be adjusted with the door in place on the hinge assembly 70 that is mounted to the front surface 14 of the refrigerator cabinet 12. In this way, the present concept provides an integrated height adjustable hinge assembly 70 that is fully integrated into a door closure assembly 50 as further described below with reference to FIG. 7A.

With further reference to FIG. 6, the hinge shaft 84 is shown having first and second collars 108, 110 disposed on opposite sides 80A, 80B of the bracket portion 80 for securely mounting the hinge shaft 84 to the mounting aperture 82. The hinge shaft 84 further includes a cylindrical body portion 112 which upwardly extends from the bracket portion 80 in assembly. The cylindrical body portion 112 includes retention ribs 112A that extend outwardly from the cylindrical body portion 112. The cylindrical body portion 112 generally defines an inner cavity 114 in which the set screw 100 is received, along with a portion of the hinge bushing 90, as further described below.

With further reference to FIG. 6, the hinge bushing 90 is shown received on the hinge shaft 84 at the cylindrical body portion 112 thereof. Specifically, the outer portion 92 is received over the cylindrical body portion 112 of the hinge shaft 84, thereby interfacing with an outer surface 116 of the cylindrical body portion 112 and retention ribs 112A in a splined engagement as further described below. The outer portion 92 of the hinge bushing 90 includes a shoulder portion 120 having an inner diameter at 122 configured to be complimentarily received over the outer surface 116 of the cylindrical body portion 112 of the hinge shaft 84. The outer portion 92 of the hinge bushing 90 further includes a tubular receiving portion 124 having internally disposed retention ribs 126 configured to complimentarily receive the retention ribs 112A of the cylindrical body portion 112 of the hinge shaft 84 in a splined engagement. In the embodiment shown in FIG. 6, a spacer 130 is shown disposed around an upper portion of the shoulder portion 120 of the outer portion 92 of the hinge bushing 90.

Referring again to FIG. 6, the inner portion 94 of the hinge bushing 90 is shown generally received within the outer portion 92 of the hinge bushing 90. The inner portion 94 of the hinge bushing 90 includes a generally stepped configuration between an upper portion 132 and a lower portion 134 thereof. The lower portion 134 is generally received within the tubular receiving portion 124 of the outer portion 92, and yet is spaced-apart therefrom to define a receiving channel 140 therebetween for receiving the cylindrical body portion 112 of the hinge shaft 84 therein. The lower portion 134 further includes a lower surface 136 which is configured to abut the abutment surface 104 of the set screw 100 in assembly. In this way, as the set screw 100 moves vertically along the path as indicated by arrow A (FIG. 7A), the engagement of the abutment surface 104 of the set screw 100 and the lower surface 136 of the hinge bushing 90 will move the hinge bushing 90 vertically along the cylindrical body portion 112 of the hinge shaft 84. This movement generally correlates to a vertical adjustment of a door assembly associated with the hinge assembly 70 as the spacer 130, or the shoulder portion 120 alone, acts on an engagement surface 47 of the door 20 shown in FIG. 7A, to move the door 20 vertically along the path indicated by arrow B.

With further reference to FIG. 6, the inner portion 94 of the hinge bushing 90 includes a generally hollow interior defining an interface channel 142 having upper and lower portions 144, 146 with a transition area 147 disposed therebetween. The upper portion 144 is generally larger than the lower portion 146, and the transition portion 147 is generally an angled portion extending between the upper portion 144 and the lower portion 146. The interface channel 142 is configured to receive the stepped pivot shaft 54 of the door closure assembly 50 in assembly as further described below with reference to FIG. 7A.

Referring now to FIG. 7A, the set screw 100 is shown engaged with the threaded aperture 96 of the hinge shaft 84 for vertical movement along the path as indicated by arrow A. This vertical movement correlates into movement of the hinge bushing 90 by the engagement of the abutment surface 104 of the set screw 100 and the lower surface 136 of the inner portion 94 of the hinge bushing 90. As described above, the inner portion 94 of the hinge bushing 90 includes an interface channel 142 having an upper portion 144 and a lower portion 146. The pivot shaft 54 of the door closure assembly 50 includes an upper portion 54A, a middle portion 54B, a lower portion 54C and a transition portion 54D. The pivot shaft 54 is generally received within the interface channel 142 of the hinge bushing 90, such that the lower portion 54C of the pivot shaft 54 is received in the lower portion 146 of the interface channel 142, thereby providing a first friction interface I1 between the lower portion 54C of the pivot shaft 54 and the lower portion 134 of the inner portion 94 of the hinge bushing 90. A second frictional interface I2 is located at the engagement of the middle portion 54B of the pivot shaft 54 with the upper portion 132 of the inner portion 94. With the stepped configuration of the pivot shaft 54, at upper and lower portions 54A, 54C with transition portion 54D, and the stepped configuration of the interface channel 142, at portions 144, 146 with transition portion 147, the pivot shaft 54 is closely received within the interface channel 142, thereby providing tight fit contact regions I1 and I2 between the hinge bushing 90 and the pivot shaft 54 of the door closure assembly 50, to radially constrain the pivot shaft 54 within the hinge bushing.

As further shown in FIG. 7A, a third contact region or friction interface I3 is disposed at the engagement of the upper portion 54A of the pivot shaft 54 with a beveled edge 133 disposed at an uppermost part of the upper portion 144 of the interface channel 142. Referring now to FIG. 7B, the pivot shaft 54 is shown with an upper portion 54A, a middle portion 54B, and a lower portion 54C. A first transition portion 54D is disposed between the lower portion 54C and the middle portion 54B, and a second transition portion 54E is shown disposed between the middle portion 54B and the upper portion 54A. Interfaces I1 and I2 are indicated at the middle portion 54B and lower portion 54C, respectively, while interface I3 is shown disposed at the upper portion 54C. Interface I3 is configured for vertical engagement of the pivot shaft 54 with the hinge bushing 90, while interfaces I1 and I2 radially constrain the pivot shaft 54. In order to increase the robustness of the connection between the hinge bushing 90 and the door closure assembly 50, a suitable grease or gel (such as Nyogel 774 VH) can be applied to the interfaces I1, I2 and I3 between interface channel 142 and the pivot shaft 54, as well as to the interfaces of the receiving channel 140 of the hinge bushing 90 and the cylindrical body portion 112 of the hinge shaft 84. The addition of the grease or gel is contemplated to reduce or eliminate any noises associated with the use of the present concept that may be caused by dimension variation of the component parts in assembly.

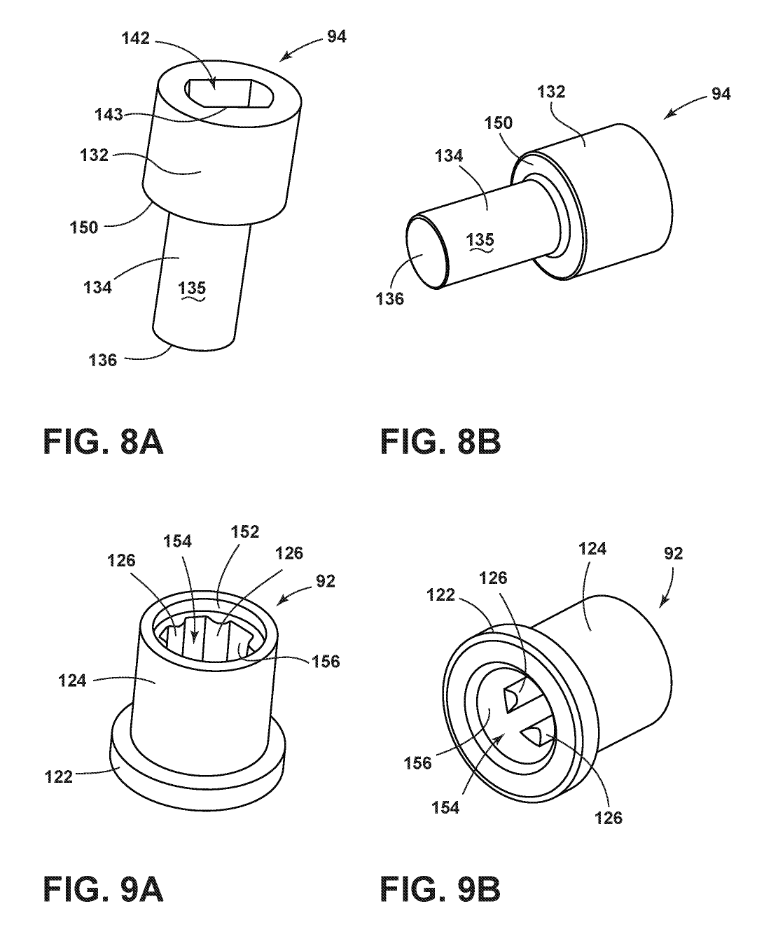

Referring now to FIGS. 8A and 8B, the inner portion 94 of the hinge bushing 90 is shown having upper portion 132 and lower portion 134 with interface channel 142 opening into both the upper portion 132 and lower portion 134. An oblong opening 143 is disposed in the upper portion 132 of the inner portion 94 and opens into the interface channel 142. The configuration of the oblong opening 143 provides for a tight grip against the pivot shaft 54 of the door closure assembly 50, for rotation of the pivot shaft 54 during opening and closing of the door. It is contemplated that the opening of a refrigerator door will cause the pivot shaft 54 to rotate and load the door closure assembly 50 which is then biased for providing a closing movement of the door from the open position towards the closed position. An abutment surface 150 is disposed between the upper portion 132 and lower portion 134 and is configured to abut a portion of the outer portion 92 of the hinge bushing 90 in assembly. The lower surface 136 of the lower portion 134 is further shown in FIGS. 8A and 8B, and is a substantially planar solid surface for abutting the abutment surface 104 of the set screw 100 as shown in FIG. 6.

Referring now to FIGS. 9A and 9B, the outer portion 92 of the hinge bushing 90 is shown having the tubular portion 124 extending upwardly from the shouldered portion 120. The tubular receiving portion 124 generally includes an inset portion 152 which is configured to receive the abutment surface 150 of the inner portion 94 in assembly. The tubular receiving portion 124 generally includes an inner cavity 154 defined by an inner wall 156 from which the retention ribs 126 inwardly extend. In assembly, as best shown in FIG. 6, the retention ribs 126 matingly engage the retention ribs 112A of the cylindrical body portion 112 of the hinge shaft 84 when the cylindrical body portion 112 of the hinge shaft 84 is received within the receiving channel 140 formed between the inner portion 94 and outer portion 92 of the hinge bushing 90.

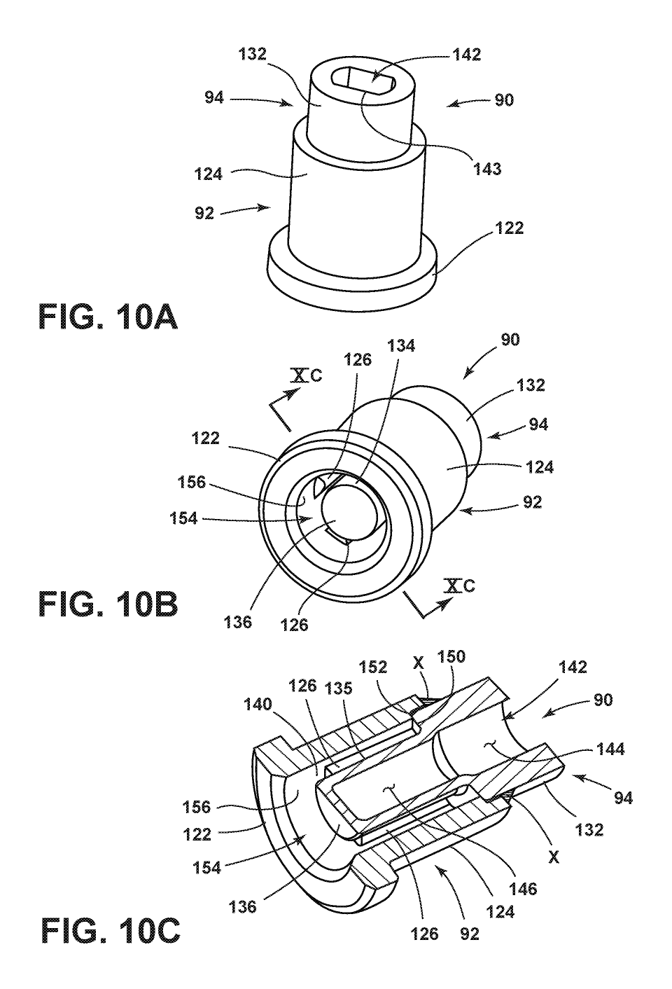

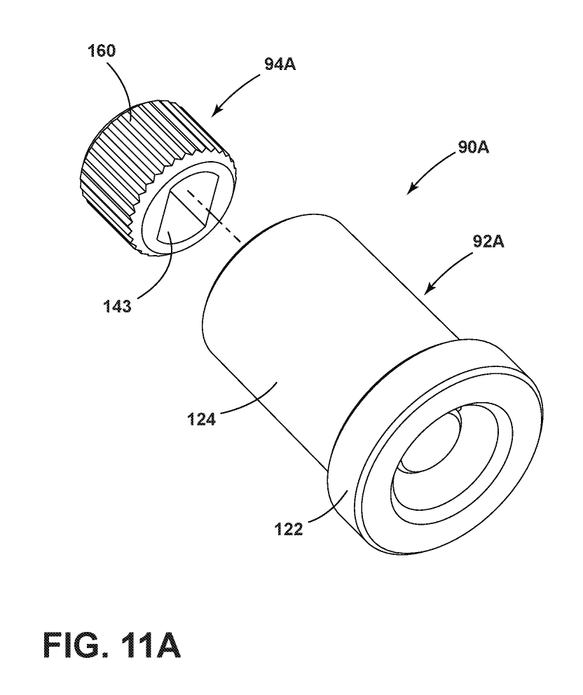

Referring now to FIGS. 10A and 10B, the hinge bushing 90 is shown in an assembled form with the inner portion 94 received in the outer portion 92. Specifically, the lower portion 134 of the inner portion 94 is received within the inner cavity 154 of the outer portion 92. The inner cavity 154 defines a receiving channel between the inner portion 94 and outer portion 92, which is identified by reference numeral 140 in FIG. 10C.

Referring now to FIG. 10C, the inner portion 94 is received in the outer portion 92 to define the hinge bushing 90. The abutment surface 150 is shown received in the inset portion 152 and welds X are contemplated to surround the connection of the inner portion 94 and outer portion 92 to fixedly secure the inner portion 94 and outer portion 92 together. The receiving channel 140 is shown disposed between the inner wall 156 of inner cavity 154 of the outer portion 92, and the outer surface 135 of the lower portion 134 of the inner portion 94.

Referring again to FIG. 5B, the hinge assembly 70 is shown coupled to the with the hinge bushing 90 received on the hinge shaft 84 (better shown in FIG. 6) disposed at the distal end 81 of the bracket portion 80 of the bracket member 72. The hinge shaft 84 is coupled to the bracket portion 80 such that the cylindrical body portion 112 and retention ribs 112A will guide the placement of the hinge bushing 90 as the cylindrical body portion 112 and retention ribs 112A of the hinge shaft 84 are received in the receiving channel 140 of the hinge bushing 90, as best shown in FIG. 6. As noted above, with reference to FIG. 6, the hinge bushing 90 includes a tubular receiving portion 124 having internally disposed retention ribs 126 configured to complimentarily receive the retention ribs 112A of the cylindrical body portion 112 of the hinge shaft 84 in a splined engagement. This splined engagement provides for a configuration wherein the hinge bushing 90 is coupled to the hinge shaft 84 in an angled manner. Specifically, the hinge bushing 90 shown FIG. 5B is positioned on the hinge shaft 84 in such a manner that the hinge bushing 90 (and the oblong aperture 143 of the inner portion 94) is at an 85° angle as indicated at α1 relative the front surface 14 to which the hinge assembly 70 is coupled. In this way, when the door closure assembly 50 is received on the hinge bushing 90, as shown in FIG. 5C, the door closure assembly 50 will have a 5° pre-tensioned angle shown in FIG. 5C at α2 relative to the front surface 14 of the refrigerator cabinet 12. The mounting of the door closure assembly 50 at a pre-tensioned angle provides for a constant torque on the doors 18, 20 (FIG. 1), to ensure that the doors 18, 20 are consistently sealed against the gaskets of the refrigerator cabinet. While the pre-tensioned angle is shown in FIG. 5C as being 5°, it is contemplated that pre-tensioned angle may be anywhere from about 3° to about 8° to provide a suitable pre-tension angle for the door closure assembly 50 to seal properly.

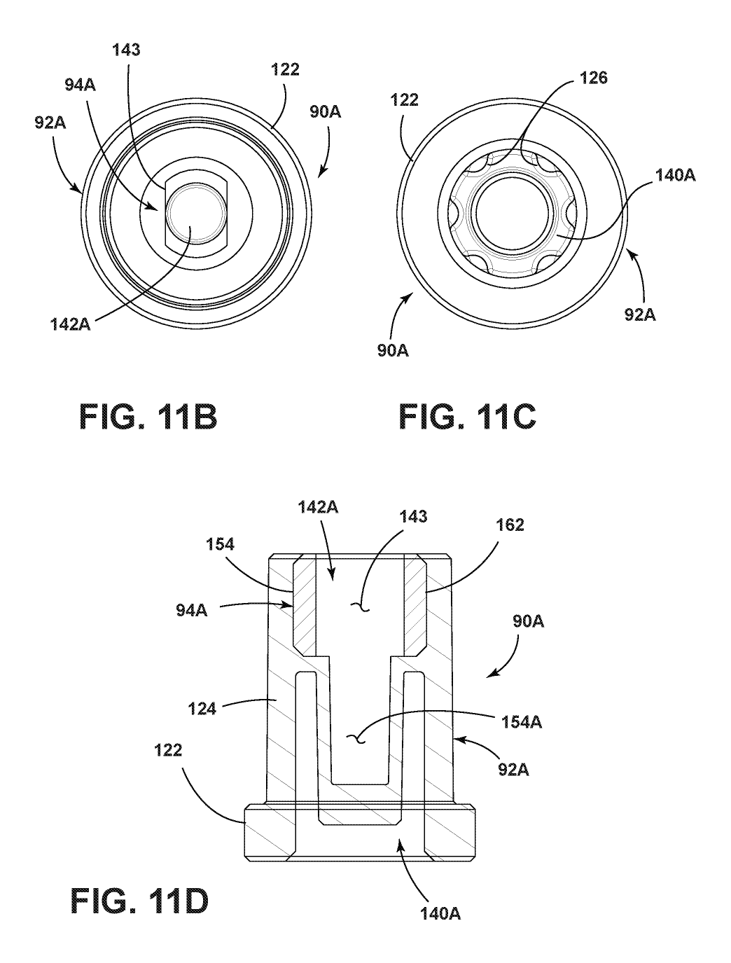

Referring now to FIGS. 11A-11D, another embodiment of a hinge bushing 90A is shown in an exploded view (FIG. 11A) with an inner portion 94A exploded away from an outer portion 92A. Specifically, the inner portion 94A is configured to be received within an upper inner cavity 154 (FIG. 11D) of the outer portion 92A. The inner portion 94A includes a splined exterior surface 160 with an oblong opening 143 disposed therethrough. Much like hinge bushing 90 described above, the oblong opening 143 is configured to receive the pivot shaft 54 of the door closure assembly 50 (FIGS. 3A and 3B). The splined exterior surface 160 of the inner portion 94A is configured to grip and couple to an interior surface 162 (FIG. 11D) of the outer portion 92A as the outer portion 92A is overmolded to the inner portion 94A. Thus, the hinge bushing 90A is an overmolded hinge bushing wherein the inner portion 94A is contemplated to be comprised of a metal material, and further wherein the outer portion 92A is contemplated to be comprised of a polymeric material molded over the inner portion 94A. With this robust overmolded configuration, the hinge bushing 90A does not require a weld between the inner and outer portions 94A, 92A as used with hinge bushing 90 described above.

With specific reference to FIG. 11D, the upper inner cavity 154 of the outer portion 92A includes a stepped portion 154A which together with the oblong opening 143, defines an interference channel 142A (FIG. 11D) between the inner portion 94A and outer portion 92A. As further shown in FIG. 11D, the outer portion 92A includes a receiving channel 140A. In assembly, and much like receiving channel 140 described above with reference to hinge bushing 90, the cylindrical body portion 112 of the hinge shaft 84 is received within the receiving channel 140A that is integrally formed in the outer portion 92A of the hinge bushing 90A. As best shown in FIGS. 11A and 11D, the tubular receiving portion 124 of the outer portion 92A provides for a solid cylindrical outer configuration as compared to the stepped outer configuration of the hinge bushing 90 described above.

With specific reference to FIG. 11B, the hinge bushing 90A is shown from a top view with the inner portion 94A received within the outer portion 92A, such that the interface channel 142A is defined.

With specific reference to FIG. 11C, the hinge bushing 90A is shown from a bottom view, such that the receiving channel 140A is shown as integrally formed in the outer portion 92A alone. Much like receiving channel 140 described above, receiving channel 140A includes retention ribs 126 configured to complimentarily receive the retention ribs 112A of the cylindrical body portion 112 of the hinge shaft 84 in a splined engagement. Thus, the hinge busing 90A provides for a splined engagement of the inner portion 94A with the outer portion 92A, as well as a splined engagement of the cylindrical body portion 112 of the hinge shaft 84 with the outer portion 92A. Thus, the hinge bushing 90A makes for a robust coupling between a hinge assembly and a door closure assembly.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

What is claimed is:

1. A refrigerator, comprising:
a refrigerator cabinet having a front opening;
a door rotatably coupled to the refrigerator cabinet between open and closed positions relative to the front opening;
a door closure assembly received in a channel disposed in an interior of the door, the door closure assembly including a receiving aperture;
a bracket member fixed to a front surface of the refrigerator cabinet adjacent the front opening;
a hinge shaft upwardly extending from the bracket member that is at least partially received in the receiving aperture of the door closure assembly;
a hinge bushing installed between the hinge shaft and the door closure assembly; and
a set screw threadingly coupled to and vertically adjustable along a threaded aperture disposed in an inner cavity of the hinge shaft, wherein the set screw abuts the hinge bushing to vertically adjust a position of the hinge bushing in response to vertical adjustment of the set screw along the threaded aperture.

2. The refrigerator of claim 1, wherein the hinge bushing includes a receiving channel and an interface channel.

3. The refrigerator of claim 2, wherein the hinge shaft includes a cylindrical body portion received in the receiving channel of the hinge bushing.

4. The refrigerator of claim 3, including:
a pivot shaft disposed on the door closure assembly, wherein the pivot shaft is received in the interface channel of the hinge bushing.

5. The refrigerator of claim 4, wherein the pivot shaft of the door closure assembly includes a stepped configuration between an upper portion and a lower portion of the pivot shaft, wherein the upper portion of the pivot shaft is larger than the lower portion of the pivot shaft.

6. The refrigerator of claim 5, wherein the interface channel of the hinge bushing includes a stepped configuration between an upper portion and a lower portion of the interface channel, wherein the upper portion of the interface channel is larger than the lower portion of the interface channel.

7. The refrigerator of claim 6, including:
a first interface contact region located between the upper portion of the interface channel and the middle portion of the pivot shaft;
a second interface contact region located between the lower portion of the interface channel and the lower portion of the pivot shaft; and
a third interface contact region, located between an uppermost portion the upper portion of the interface channel and the upper portion of the pivot shaft, wherein the first and second interface contact regions are configured to restrain the pivot shaft radially, and further wherein the third interface contact region engages the pivot shaft vertically.

8. The refrigerator of claim 1, wherein the hinge bushing includes a shoulder portion configured to abut an engagement surface of the door for moving the door vertically as the hinge bushing is vertically adjusted.

9. A refrigerator, comprising:
a refrigerator cabinet having a front opening;
a door rotatably coupled to the refrigerator cabinet between open and closed positions relative to the front opening;
a door closure assembly received in a channel disposed in a bottom surface of the door, the door closure assembly including a receiving aperture with a downwardly extending pivot shaft;
a bracket member coupled to a front surface of the refrigerator cabinet and extending outwardly therefrom;
a hinge shaft upwardly extending from the bracket member having a cylindrical body portion with an inner cavity;
a hinge bushing having an outer portion and an inner portion with a receiving channel disposed therebetween in which the cylindrical body portion of the hinge shaft is received; and
a set screw threadibly coupled to and vertically adjustable along a threaded aperture disposed in the inner cavity of the hinge shaft, wherein the set screw abuts a lower surface of the inner portion of the hinge bushing to vertically adjust a position of the hinge bushing in response to a rotation of the set screw.

10. The refrigerator of claim 9, wherein the inner portion of the hinge bushing further includes an interface channel.

11. The refrigerator of claim 10, wherein the pivot shaft of the door closure assembly is closely received in the interface channel of the inner portion of the hinge bushing, such that the door closure assembly is disposed at a pre-tensioned angle relative to the front surface of the refrigerator cabinet.

12. The refrigerator of claim 9, wherein the cylindrical body portion of the hinge shaft further includes a plurality of retention ribs disposed on an outer surface thereof.

13. The refrigerator of claim 12, wherein the outer portion of the hinge bushing includes a plurality of retention ribs extending inwardly into the receiving channel for splined engagement with the retention ribs disposed on the outer surface of the cylindrical body portion of the hinge shaft.

14. The refrigerator of claim 9, wherein the inner portion of the hinge bushing includes an upper portion and a lower portion with the lower surface disposed on the lower portion, wherein the lower portion is received in the inner cavity of the hinge shaft for abutting engagement between the set screw and the lower surface of the lower portion.

15. A height-adjustable door hinge assembly, comprising:
a bracket member having a mounting aperture;
a hinge shaft received in the mounting aperture of the bracket member having a cylindrical body portion upwardly extending therefrom;
a hinge bushing including an inner portion received in an outer portion to define a receiving channel disposed between the inner portion and the outer portion in which the cylindrical body portion of the hinge shaft is received; and
a set screw threadingly coupled to a threaded aperture disposed in the hinge shaft, wherein the set screw abuts the inner portion of the hinge bushing to vertically adjust a position of the hinge bushing in response to vertical adjustment of the set screw.

16. The door hinge assembly of claim 15, wherein the inner portion of the hinge bushing includes an interface channel.

17. The door hinge assembly of claim 16, wherein the interface channel of the hinge bushing includes a stepped configuration between an upper portion and a lower portion of the interface channel.

18. The door hinge assembly of claim 16, including
a door closure assembly operably coupled to the interface channel of the hinge bushing.

19. The door hinge assembly of claim 15, wherein the cylindrical body portion of the hinge shaft further includes a plurality of retention ribs disposed on an outer surface thereof.

20. The door hinge assembly of claim 19, wherein the outer portion of the hinge bushing includes a plurality of retention ribs extending inwardly into the receiving channel for splined engagement with the retention ribs disposed on the outer surface of the cylindrical body portion of the hinge shaft.
